(19) United States
(12) Patent Application Publication
(10) Pub. No.: US 2025/0286900 A1
(43) Pub. Date: Sep. 11, 2025

(54) NETWORK SECURITY DEVICE WITH INTEGRATED DISPLAY

(71) Applicant: Fortinet, Inc., Sunnyvale, CA (US)

(72) Inventors: Tzukuang Chang, Sunnyvale, CA (US); Michael Xie, Los Altos, CA (US); TengWei Tzou, Sunnyvale, CA (US); Sieu Luu, Fremont, CA (US); Jun Yin Lu, Surrey (CA); Zhaoguang Lei, Sunnyvale, CA (US)

(73) Assignee: Fortinet, Inc., Sunnyvale, CA (US)

(21) Appl. No.: 19/074,043

(22) Filed: Mar. 7, 2025

Related U.S. Application Data
(60) Provisional application No. 63/563,251, filed on Mar. 8, 2024.

(51) Int. Cl. H04L 9/40

(52) U.S. Cl. CPC H04L 63/1416; H04L 63/1425

(57) ABSTRACT

Systems and methods for conveying operating status of a security appliance via an integrated display are provided. In one example, one or more directives relating to health information and/or event logs to be displayed on an integrated display of a security appliance in response to an occurrence of a predetermined or configurable trigger event within the security appliance may be received from a user, administrator, or a technician. Thereafter, the security appliance may monitor for the occurrence of the predetermined or configurable trigger event. After detecting the occurrence of the predetermined or configurable trigger event, the selected health information and/or event logs may be presented on the integrated display in accordance with a specified screen configuration to facilitate determination of an operating status of the security appliance without requiring the use of a command-line interface (CLI) or browser-based interface of the security appliance.

### CROSS-REFERENCE TO RELATED APPLICATIONS

This application claims the benefit of priority of U.S. Provisional Application No. 63/563,251, filed on Mar. 8, 2024, which is hereby incorporated by reference in its entirety for all purposes.

### BACKGROUND

### Field

Various embodiments of the present disclosure generally relate to network security devices. In particular, some embodiments relate to enhancing a network security device to include an integrated liquid-crystal display (LCD), light-emitting diode (LED) display, LED-backlit LCD, or the like, for example, to facilitate a quick understanding of the device operating status (e.g., via color, pattern, and/or display of default or configurable metrics and/or event data, for example, extracted from event data logs).

### Description of the Related Art

Network security devices (e.g., next generation (NG) firewall devices, web application firewalls (WAFs), secure web gateways (SWGs), unified threat protection (UTP) capable access points (APs), managed APs, and the like) generally provide a command-line interface (CLI) or a browser-based interface through which an end user or administrative user can interact with the network security device.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is an example of a computer system representing a network security device in accordance with various embodiments of the present disclosure.

FIG. 2 is an example of a network security device showing an example of an integrated display in accordance with an embodiment of the present disclosure.

FIG. 3 is a flow diagram illustrating a set of operations for configuring an integrated display and/or an RGB lighting pattern of a network security device in accordance with an embodiment of the present disclosure.

FIG. 4 is a flow diagram illustrating a set of operations for configuring an integrated touchscreen display of a network security device in accordance with an embodiment of the present disclosure.

### DETAILED DESCRIPTION

Systems and methods are described for use of an integrated display of a network security device. Existing network security devices do not include integrated displays and generally provide a CLI and/or browser-based interface to facilitate remote configuration and/or access to desired information. One limitation of such a configuration is that a data center technician or other administrative user in physical proximity to the network security device has no ability to simply look at the network security device to understand the operating status (e.g., temperature, network flow status, security alerts, normal operating conditions, abnormal operating conditions, etc.) of the network security device.

Embodiments described herein seek to allow a technician or administrative user in proximity to a network security device to be able to quickly understand the device operating status via displayed statistics or metrics on an integrated display (e.g., LCD, LED, etc.) of the network security device or via a color or pattern (e.g., blinking) of the display and/or LEDs associated with the network security device. In various embodiments, the particular information indicative of operating status of the device may be configurable via an integrated touch screen display or via a CLI or browser-based interface of the network security device.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network security appliance,” a “network security device,” or a “security appliance” generally refers to a device or appliance in physical form that is operable to perform one or more security functions or security management functions. A network security device may reside within the particular network that it is protecting. Some network security devices may be implemented as general-purpose computers or servers with appropriate software operable to perform one or more security functions. Other network security devices may also include custom hardware (e.g., one or more custom Application-Specific Integrated Circuits (ASICs)). For example, while there are differences among network security device vendors, network security devices may be classified into three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines one or more CPUs, CPs, NPs. Mid-range network security devices may include one or more multi-core CPUs, one or more separate NP Application-Specific Integrated Circuits (ASICs), and one or more separate CP ASICs. At the high-end, network security devices may have multiple NPs and/or multiple CPs. A network security device is typically associated with a particular network (e.g., a private enterprise network) on behalf of which it provides one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DOS) detection and mitigation, encryption (e.g., Internet Protocol Secure (IPSec), TLS, SSL), application control, Voice over Internet Protocol (VOIP) support, Virtual Private Networking (VPN), data loss prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include secure wireless APs (e.g., the FORTIAP UTP Access Point Series of secure wireless APs), network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DOS attack detection appliances (e.g., the FORTIDDOS family of DOS attack detection and mitigation appliances).

### Example Network Security Device

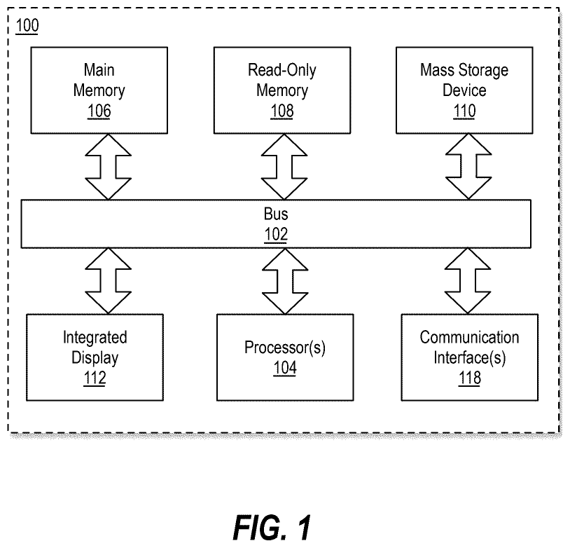

FIG. 1 is an example of a computer system representing a network security device 100 in accordance with various embodiments of the present disclosure. Notably, components of network security device 100 described herein are meant only to exemplify various possibilities. In no way should example network security device 100 limit the scope of the present disclosure.

In the context of the present example, the network security device 100 includes a bus 1602 or other communication mechanism for communicating information, and one or more processing resources (e.g., one or more hardware processors 104) coupled with bus 102 for processing information. Hardware processors 104 may include, for example, one or more general purpose microprocessors available from one or more current or future microprocessor manufactures (e.g., Intel Corporation, Advanced Micro Devices, Inc., and/or the like) and/or one or more special purpose processors (e.g., CPs, NPs, and/or accelerators or co-processors). In some examples, the one or more processing resources may be part of an ASIC-based security processing unit (e.g., the FORTISP family of security processing units available from Fortinet, Inc. of Sunnyvale, CA).

Network security device 100 also includes a main memory 106, such as a random access memory (RAM) or other dynamic storage device, coupled to bus 102 for storing information and instructions to be executed by processor(s) 104. Main memory 106 also may be used for storing temporary variables or other intermediate information during execution of instructions to be executed by processor(s) 104. Such instructions, when stored in non-transitory storage media accessible to processor(s) 104, render network security device 100 into a special-purpose machine that is customized to perform the operations specified in the instructions.

Network security device 100 further includes a read only memory (ROM) 1608 or other static storage device coupled to bus 1602 for storing static information and instructions for processor(s) 104. A storage device 110, e.g., a magnetic disk, optical disk or flash disk (made of flash memory chips), is provided and coupled to bus 102 for storing information and instructions.

Network security device 100 may also include an integrated display 112 coupled to bus 102. The integrated display 112 may be an LCD, an LED display, an Organic LED Display or the like, for displaying information to a technician or administrative user of the network security device 100. The integrated display 112 may be in the form of a touchscreen that enables the technician or administrative user to interact directly with what is displayed, instead of using a mouse, touchpad, or other such devices. As noted above, at least one advantage of having the integrated display 112 is the ability for a technician or administrative user in proximity to the network security device 100 to be able to quickly understand the device operating status via displayed statistics or metrics on the integrated display 112

Network security device 100 may implement the techniques described herein using customized hard-wired logic, one or more ASICs or FPGAs, firmware or program logic which in combination with the computer system causes or programs computer system 1600 to be a special-purpose machine. According to one embodiment, the techniques herein are performed by computer system 1600 in response to processor(s) 1604 executing one or more sequences of one or more instructions contained in main memory 1606. Such instructions may be read into main memory 1606 from another storage medium, such as storage device 1610. Execution of the sequences of instructions contained in main memory 1606 causes processor(s) 1604 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 110. Volatile media includes dynamic memory, such as main memory 106. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 102. Transmission media can also take the form of acoustic or light waves, such as those generated during radio-wave and infra-red data communications.

Various forms of media may be involved in carrying one or more sequences of one or more instructions to processor(s) 104 for execution. For example, the instructions may initially be carried on a magnetic disk or solid state drive of a remote computer. The remote computer can load the instructions into its dynamic memory and send the instructions over a telephone line using a modem. A modem local to network security device 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 606, from which processor(s) 104 retrieve and execute the instructions. The instructions received by main memory 106 may optionally be stored on storage device 110 either before or after execution by processor(s) 104.

Network security device 1600 also includes a communication interface 118 coupled to bus 102. Communication interface 118 may provide a two-way data communication coupling to a network link (not shown) that is connected to a local network (not shown). For example, communication interface 118 may be an integrated services digital network (ISDN) card, cable modem, satellite modem, or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network security device 100 can send messages and receive data, including program code, through the network(s), the network link and communication interface 118. In some examples, a server or management device (not shown) might transmit requested code for an application program through Internet (not shown), an internet service provider (ISP) (not show), a local network land communication interface 118. The received code may be executed by processor(s) 104 as it is received, or stored in storage device 110, or other non-volatile storage for later execution.

### Example Integrated Display

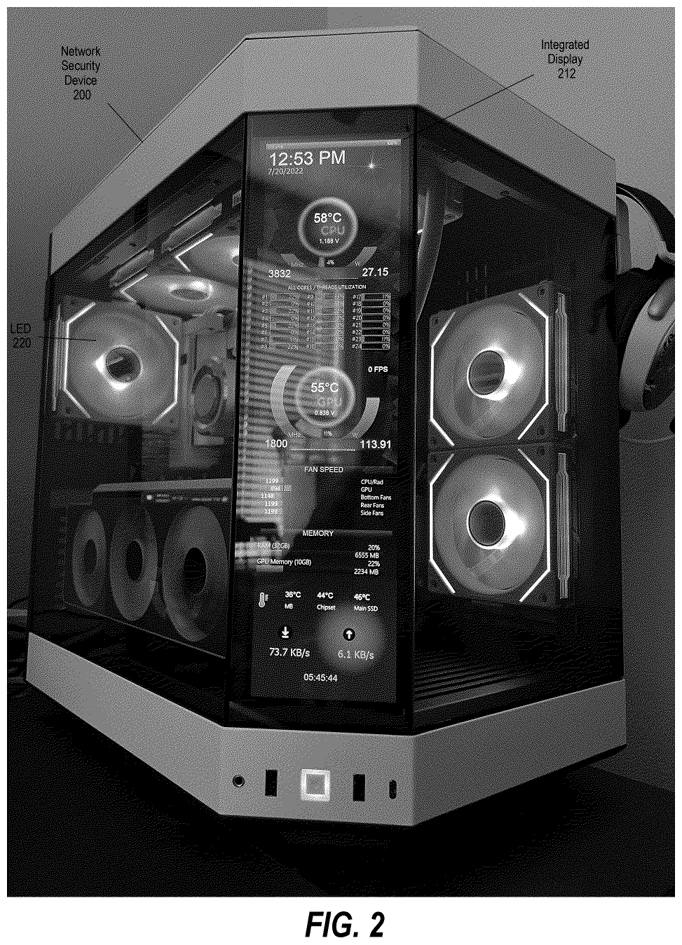

FIG. 2 is an example of a network security device 200 showing an example of an integrated display 212 in accordance with an embodiment of the present disclosure. Network security device 200 may be analogous to network security device 100 and integrated display 212 may be analogous to integrated display 112. In the context of the present example, the integrated display 212 is shown depicting operating status of the network security device 200, for example, including a temperature of one or more processing resources (e.g., a CPU, a CP, an NP, an ASIC, a co-processor, etc.), a temperature of the motherboard, a chipset, storage device(s) (e.g., one or more hard-disk drives (HDDs) and/or one or more solid-state drives (SSDs)), uplink and downlink speed or bandwidth usage. The integrated display 112 may also present statistics or metrics regarding processing resource utilization (e.g., overall and/or the amount or percentage of load handled by individual processor cores), fan speed, memory utilization (e.g., percent free, percent used, units of storage (e.g., megabytes (MBs) free, units of storage used, etc.), disk space (e.g., storage capacity used and/or available on the network security device 100). Various other statistics or metrics may include device availability (e.g., whether the network security device 100 is online or offline), network flow status, numbers and/or types of connections for one or more protocols, a number and/or type of security alerts, device errors (e.g., the number and/or types of errors encountered by the network security device 100 and other network error metrics/statistics, for example, dropped packets and/or packet loss rate), uptime (e.g., a total time the network security device has been operational without interruption), processing resource voltage, real-time power usage (e.g., in watts), clock speed, etc.

The immediate availability of such information at a glance via presentation on the integrated display 212 may offer several benefits including:
Proactive problem solving: Network administrators can detect potential issues early and address them before they escalate by having easy access to various network security device performance statistics/metrics.
Better management and control: Availability of information regarding the operating status of the network security device 200 provides insights into network security device performance and usage, enabling better resource management and control.
Improved network efficiency: Visibility into information regarding the operating status of the network security device 200 may also help improve network efficiency by identifying bottlenecks and other issues.
Enhanced security: Visibility into information regarding the operating status of the network security device 200 may also help detect unusual activity that could indicate a security breach.

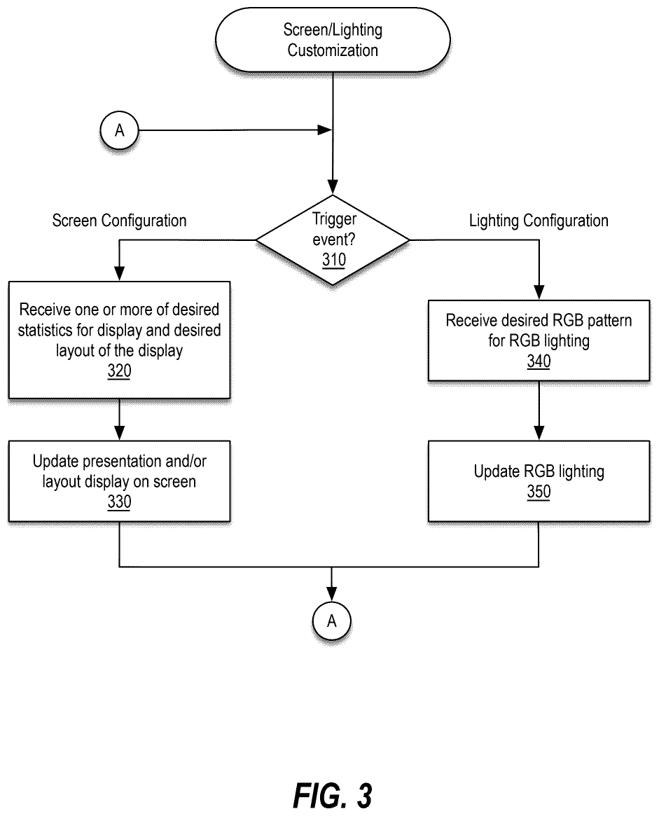

In the context of the present example, network security device 200 is also shown including one or more RGB lights (e.g., LED 220). One or both of the layout and content (e.g., statistics/metrics and/or other information indicative of operating status) and RGB patterns and/or colors may be configurable. For example, an administrative user may be provided with the ability to selectively enable/disable display of various statistics/metrics and/or indicate an order or position of their respective display on the screen. Similarly, the administrative user may be provided with the ability to configure RGB patterns (e.g., one or more desired colors expressed in terms of values of the three base components of red, green, and blue, transition times among multiple desired colors, etc.) for individual or all of the one or more RGB lights. A non-limiting example of screen/lighting customization is described further below with reference to FIG. 3.

### Example Screen/Lighting Customization

FIG. 3 is a flow diagram illustrating a set of operations for configuring an integrated display (e.g., integrated display 112 or 212) and/or an RGB lighting pattern of a network security device (e.g., network security device 100 or 200) in accordance with an embodiment of the present disclosure.

At decision block 310, it may be determined whether a trigger event has occurred. If the trigger event is a request to configure the screen, the processing continues with block 320; otherwise, if the trigger event is a request to configure the lighting, then processing branches to block 340. Depending on the particular implementation, the trigger event may be in the form of a CLI command, a command received via browser-based interface of the network security device, or a command received via a touchscreen of the integrated display.

At block 320, information regarding one or more desired statistics for display and/or desired layout of the display may be received.

At block 330, the presentation and/or layout of the display on the screen are updated in accordance with the desired configuration received in block 320. After completion of block 330, processing may loop back to decision block 310 to await a subsequent trigger event.

At block 340, information regarding a desired RGB pattern for the RGB lighting is received.

At block 350, the RGB lighting updated in accordance with the desired RGB pattered received in block 340. After completion of block 350, processing may loop back to decision block 310 to await a subsequent trigger event.

While in the context of the flow diagram of FIG. 3 a number of enumerated blocks are included, it is to be understood that examples may include additional blocks before, after, and/or in between the enumerated blocks. Similarly, in some examples, one or more of the enumerated blocks may be omitted and/or performed in a different order.

### Example Screen/Lighting Customization

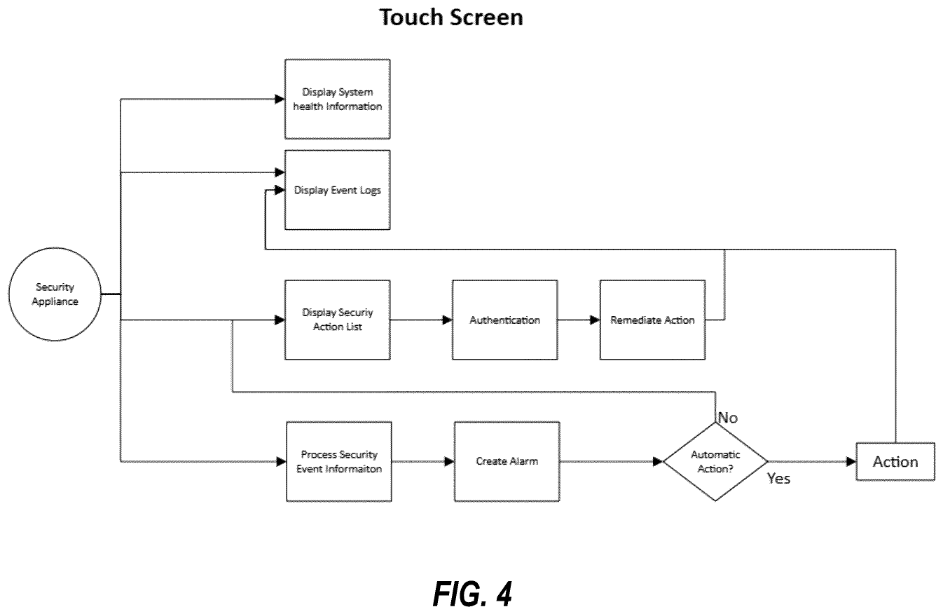

FIG. 4 is a flow diagram illustrating a set of operations for configuring an integrated touchscreen display of a network security device in accordance with an embodiment of the present disclosure. In one example, a user, administrator, or technician may set up trigger conditions and select desired display configuration of data to be displayed in response to the security appliance detecting existence of the conditions established. In one embodiment, default event flows and default screen configurations may be provided. Alternatively or additionally, the user, administrator, or technician may be provided with the ability to customize the system health information and/or event logs to be presented on the limited-size LCD screen, thereby allowing preferred event flows to be followed.

Embodiments of the present disclosure include various steps, which have been described above. The steps may be performed by hardware components or may be embodied in machine-executable instructions, which may be used to cause one or more processing resources (e.g., one or more general-purpose and/or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers, physical and/or virtual network security appliances) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
providing a network security device with an integrated display; and
facilitating determination of an operating status of the network security device by presenting one or more of predetermined or configurable health information and event logs on the integrated display based on an occurrence of a predetermined or configurable trigger event within the network security device.

2. A non-transitory machine readable medium storing instructions, which when executed by one or more processing resources of a security appliance, cause the security appliance to:
receive selections relating to one or more of health information and event logs to be displayed on an integrated display of the security appliance based on occurrence of a predetermined or configurable trigger event within the network security device;
monitor for the occurrence of the predetermined or configurable trigger event; and
present the selected one or more of health information and event logs on the integrated display in accordance with a specified screen configuration.

3. A security appliance comprising:
an integrated display;
one or more processing resources; and
instructions that when executed by the one or more processing resources cause the security appliance to:
receive selections relating to one or more of health information and event logs to be displayed on the integrated display based on occurrence of a predetermined or configurable trigger event within the security appliance;
monitor for the occurrence of the predetermined or configurable trigger event; and
present the selected one or more of health information and event logs on the integrated display in accordance with a specified screen configuration.
